(19) United States
(12) Patent Application Publication
(10) Pub. No.: US 2024/0419481 A1
(43) Pub. Date: Dec. 19, 2024

(54) METHOD AND APPARATUS TO MIGRATE MORE SENSITIVE WORKLOADS TO FASTER CHIPLETS

(71) Applicants: Advanced Micro Devices, Inc., Santa Clara, CA (US); ATI Technologies ULC, Markham (CA)

(72) Inventors: Ashish Jain, Austin, TX (US); Ashkan Hosseinzadeh Namin, Richmond Hill (CA)

(21) Appl. No.: 18/334,363

(22) Filed: Jun. 13, 2023

(51) Int. Cl. G06F 9/46

(52) U.S. Cl. CPC G06F 9/463

(57) ABSTRACT

An apparatus and method for efficiently performance among replicated functional blocks of an integrated circuit despite different circuit behavior amongst the functional blocks due to manufacturing variations. An integrated circuit includes multiple replicated functional blocks, each being a semiconductor die with an instantiated copy of particular integrated circuitry for processing a work block. One or more of the functional blocks of the integrated circuit belong in a different performance category or bin than other functional blocks due to manufacturing variations across semiconductor dies. A scheduler assigns work blocks to the functional blocks based on whether a functional block is from a high-performance bin and whether a workload of a work block is a computation intensive workload. The scheduler assigns work blocks work blocks marked as having a memory access intensive workload to functional blocks from a lower performance bin.

### BACKGROUND

### Description of the Relevant Art

Generally speaking, a variety of semiconductor chips include at least one processor coupled to a memory. The processor processes instructions (or commands) by fetching instructions and data, decoding instructions, executing instructions, and storing results. The processor sends memory access requests to the memory for fetching instructions, fetching data, and storing results of computations. Examples of the processor are a central processor (CPU), an application specific integrated circuit (ASIC), a field programmable gate array (FPGA), multimedia circuitry, and a processor with a highly parallel microarchitecture such as a graphics processor (GPU) or a digital signa processor (DSP). In some designs, the processor, one or more other integrated circuits, and the memory are on a same die such as a system-on-a-chip (SOC), whereas, in other designs, the processor and the memory are on different dies within a same package such as a system in a package (SiP) or a multi-chip-module (MCM).

During the semiconductor manufacturing process steps for the semiconductor die, and prior to packaging the semiconductor die in the MCM or other semiconductor package, it is possible that one or more processors and other compute circuits on the semiconductor die have different circuit behavior than other iterations of the semiconductor die in another semiconductor package. These differences in behavior result from manufacturing variations across semiconductor dies that inadvertently cause different widths of metal gates and metal traces, different doping levels of source and drain regions, different thicknesses of insulating oxide layers, different thicknesses of metal layers, and so on. These manufacturing variations also affect the threshold voltages of transistors. The semiconductor dies with different circuit behavior are still used, but these semiconductor dies are placed in different performance categories or bins. When the semiconductor package utilizes multiple copies of a same semiconductor die and even when the multiple copies receive a same workload, the behavior of the resulting semiconductor chip can vary depending on which bins the semiconductor dies were selected to be placed in the semiconductor chip.

In view of the above, efficient methods and apparatuses for managing performance among replicated functional blocks of an integrated circuit despite different circuit behavior amongst the functional blocks due to manufacturing variations are desired.

### BRIEF DESCRIPTION OF THE DRAWINGS

FIG. 1 is a generalized block diagram of an apparatus that manages performance among replicated functional blocks, such as semiconductor dies, of an integrated circuit despite different circuit behavior of the functional blocks due to manufacturing variations.

FIG. 2 is a generalized diagram of a method for efficiently managing performance among replicated functional blocks of an integrated circuit despite different circuit behavior of the functional blocks due to manufacturing variations.

FIG. 3 is a generalized diagram of a method for efficiently managing performance among replicated functional blocks of an integrated circuit despite different circuit behavior of the functional blocks due to manufacturing variations.

FIG. 4 is a generalized diagram of a method for efficiently managing performance among replicated functional blocks of an integrated circuit despite different circuit behavior of the functional blocks due to manufacturing variations.

FIG. 5 is a generalized block diagram of a computing system that manages performance among replicated functional blocks, such as semiconductor dies, of an integrated circuit despite different circuit behavior of the functional blocks due to manufacturing variations.

FIG. 6 is a generalized block diagram of an integrated circuit that manages performance among replicated functional blocks, such as semiconductor dies, of an integrated circuit despite different circuit behavior of the functional blocks due to manufacturing variations.

FIG. 7 is a generalized block diagram of a scheduler that manages performance among replicated functional blocks of an integrated circuit despite different circuit behavior of the functional blocks due to manufacturing variations.

FIG. 8 is a generalized block diagram of a system-in-package (SiP) that manages performance among replicated functional blocks of an integrated circuit despite different circuit behavior of the functional blocks due to manufacturing variations.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods efficiently managing performance among replicated functional blocks of an integrated circuit despite different circuit behavior amongst the functional blocks due to manufacturing variations are contemplated. In various implementations, an integrated circuit includes multiple replicated functional blocks, each being a semiconductor die with an instantiated copy of particular integrated circuitry for processing a work block. Tasks performed by the integrated circuit are grouped into work blocks, where a “work block” is a partition of work executed in an atomic manner. The granularity of a work block can include a single instruction of a computer program, or a wave front that includes multiple work items to be executed concurrently on multiple lanes of execution of a compute circuit within a functional block.

One or more of the functional blocks of the integrated circuit belong in a different performance category or bin than other functional blocks due to manufacturing variations across semiconductor dies. The multiple functional blocks provide the same functionality, but provide different circuit behavior due to manufacturing variations between them. An example of the different circuit behavior is transistor speed, which can affect the supported maximum operating clock frequency. The hardware, such as circuitry, of a scheduler assigns work blocks to the compute circuits that process the assigned work blocks. In some implementations, the program state of a work block includes an indication that specifies a type of workload performed by the work block. Workloads of work blocks include at least a computation intensive workload and a memory access intensive workload. The scheduler assigns work blocks marked as having a computation intensive workload to functional blocks that provide higher performance with higher performance operating parameters. For example, these functional blocks are from a bin of functional blocks that are capable of operating at a higher operational clock frequency than functional blocks of another lower performance bin. Therefore, these functional blocks provide higher throughput for work blocks having a computation intensive workload.

The scheduler assigns work blocks marked as having a memory access intensive workload to functional blocks that do not provide higher performance with higher performance operating parameters. For example, these functional blocks are from a lower performance bin of functional blocks that are incapable of operating at a higher operational clock frequency due to manufacturing variations. Therefore, these functional blocks do not provide higher throughput for work blocks having a computation intensive workload. Accordingly, these functional blocks instead are assigned work blocks marked as having a memory access intensive workload.

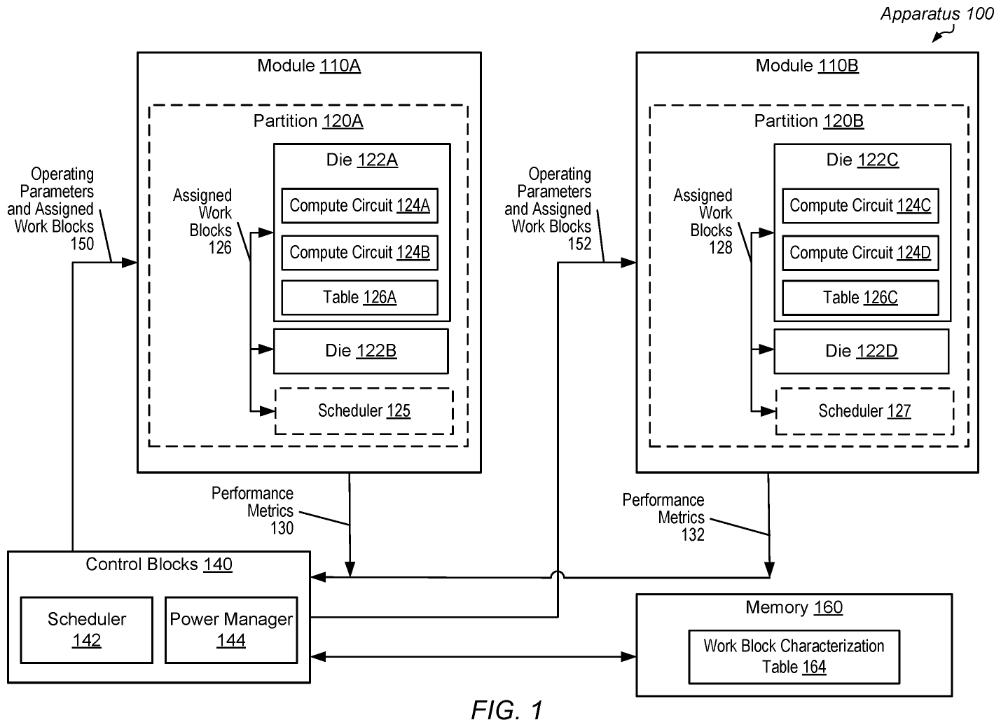

In some implementations, the functional blocks are chiplets. As used herein, a “chiplet” is also referred to as a “functional block,” or an “intellectual property block” (or IP block). However, a “chiplet” is a semiconductor die (or die) fabricated separately from other dies, and then interconnected with these other dies in a single integrated circuit in the MCM. A chiplet is a type of functional block. However, a functional block is a term that also describes blocks fabricated with other functional blocks on a larger semiconductor die such as the SoC. Therefore, a chiplet is a subset of “functional blocks” in a semiconductor chip. The scheduler assigns work blocks to the chiplets based on whether a chiplet is from a high-performance bin and whether a workload of a work block is a computation intensive workload. Further details of these techniques for efficiently managing performance among replicated functional blocks of an integrated circuit despite different circuit behavior amongst the functional blocks due to manufacturing variations are provided in the following description of FIGS. 1-8.

Referring to FIG. 1, a generalized block diagram is shown of an apparatus 100 that efficiently manages performance among replicated functional blocks of an integrated circuit despite different circuit behavior amongst the functional blocks due to manufacturing variations. In the illustrated implementation, the apparatus 100 includes the control blocks 140, a memory 160, and at least two modules such as modules 110A-110B. The module 110A includes the partition 120A that includes the semiconductor dies 122A-122B (or dies 122A-122B). The module 110B includes the partition 120B that includes the dies 122C-122D. In some implementations, each of the dies 122A-122B and 122C-122D includes one or more compute circuits. For example, die 122A includes the compute circuits 124A-124B and the die 122C includes the compute circuits 124C-124D. In addition, the die 122A includes the semiconductor die characterization table 126A (or table 126A), which stores information that specifies a performance category or bin of the die 122A. The die 122C includes the semiconductor die characterization table 126C (or table 126C), which stores information that specifies a performance category or bin of the die 122C. In an implementation, the table 126A includes information that specifies a maximum operating clock frequency for the die 122A, and the table 126C includes information that specifies a maximum operating clock frequency for the die 122C. Although not shown, the dies 122B and 122D can also include one or more compute circuits and a semiconductor die characterization table.

In various implementations, the hardware, such as circuitry, of each of the dies 122B and 122C-122D is an instantiated copy of the circuitry of the die 122A. Although only two modules 110A-110B are shown, and only two dies are shown within each of the partitions 120A-120B, other numbers of modules and compute circuits used by apparatus 100 are possible and contemplated and these numbers are based on design requirements. In some implementations, the functionality of the apparatus 100 is included as one die of multiple dies on a system-on-a-chip (SOC). In other implementations, the functionality of the apparatus 100 is implemented by multiple, separate dies that have been fabricated on separate silicon wafers and placed in system packaging known as multi-chip modules (MCMs). Other components of the apparatus 100 are not shown for ease of illustration. For example, a memory controller, one or more input/output (I/O) interface circuitry, interrupt controllers, one or more phased locked loops (PLLs) or other clock generating circuitry, one or more levels of a cache memory subsystem, and a variety of other compute circuits are not shown although they can be used by the apparatus 100.

In various implementations, the apparatus 100 is used in a desktop, a portable computer, a mobile device, a server, a peripheral device, or other. The apparatus 100 is capable of communicating with an external general-purpose central processor (CPU) that includes circuitry for executing instructions according to a predefined general-purpose instruction set architecture (ISA). The apparatus 100 is also capable of communicating with a variety of other external circuitry such as one or more of a digital signal processor (DSP), a display controller, a variety of application specific integrated circuits (ASICs), multimedia circuitry, and so forth.

The control blocks 140 include at least the scheduler 142 and the power manager 144. The control blocks 140 receive the performance metrics 130 from module 110A and performance metrics 132 from module 110B. These performance metrics 130 and 132 are values stored in performance counters across the dies 122A-122B and dies 122C-122D. These performance counters can also be distributed across other components (not shown) of the modules 110A and 110B. In some implementations, the collected data includes predetermined sampled signals. The switching of the sampled signals indicates an amount of switched capacitance. Examples of the selected signals to sample include clock gater/gating enable signals, bus driver enable signals, mismatches in content-addressable memories (CAM), CAM word-line (WL) drivers, and so forth. The collected data can also include data that indicates throughput of each of the modules 110A and 110B such as a number of retired instructions, a number of cache accesses, monitored latencies of cache accesses, a number of cache hits, a count of issued instructions or issued threads, and so forth. In an implementation, the power manager 140 collects data to characterize power consumption and a performance level of the modules 110A and 110B during particular sample intervals. The performance levels are based on one or more of the examples of the collected data.

The power manager 144 assigns a corresponding power domain to each of the modules 110A-11B. In some implementations, each of the modules 110A-11B uses a respective power domain. In such implementations, the operating parameters of the information 150 and 152 are separate values. In other implementations, the modules 110A-11B share the same power domain. In such implementations, the operating parameters of the information 150 and 152 are the same values. Depending on the implementation, the power manager 144 selects a same or a respective power management state for each of the modules 110A-110B. As used herein, a “power management state” is one of multiple “P-states,” or one of multiple power-performance states that include a set of operational parameters such as an operational clock frequency and an operational power supply voltage. Each of the power domains includes at least the operating parameters of the P-state such as at least an operating power supply voltage and an operating clock frequency. Each of the power domains also includes control signals for enabling and disabling connections to clock generating circuitry and a power supply reference. These control signals are also included in the information 150 and 152.

The compute circuits 124A-124B and 124C-124D of the modules 110A-110B include circuitry configured to perform (or “execute”) tasks (e.g., based on execution of instructions, detection of signals, movement of data, generation of signals and/or data, and so on). The tasks are grouped into work blocks. A “work block” is a partition of work executed in an atomic manner. The granularity of a work block can include a single instruction of a computer program, and this single instruction can also be divided into two or more micro-operations (micro-ops) by the apparatus 100. The granularity of a work block can also include one or more instructions of a subroutine.

The granularity of a work block can also include a wave front (or wave) assigned to multiple lanes of execution of the compute circuits 124A-124B and 124C-124D when these compute circuits are implemented as single instruction multiple data (SIMD) circuits. In such an implementation, a particular combination of the same instruction and a particular data item of multiple data items is referred to as a “work item.” A work item is also referred to as a thread. In an implementation, each of the compute circuits 124A-124B and 124C-124D is a SIMD circuit that includes 64 lanes of execution. Therefore, each of the compute circuits 124A-124B and 124C-124D (or SIMD circuits) is able to simultaneously process 64 threads. In other implementations, the compute circuits 124A-124B and 124C-124D include other types of circuitry that provides another functionality when executing on another type of assigned work block.

The scheduler 142 assigns tasks in the form of work blocks to the modules 110A-110B. In an implementation, the scheduler 142 receives work blocks to assign to the compute circuits 124A-124B and 124C-124D, and does so based on load balancing. In one implementation, the scheduler 142 is a command processor of a graphics processor (GPU), and the scheduler 142 retrieves the work blocks from a buffer such as system memory. Another processor, such as a general-purpose central processor (CPU) stores the work blocks in the buffer and sends an indication to the apparatus 100 specifying that pending work blocks are stored in the buffer. In other implementations, the scheduler 142 is included in another type of processor other than a GPU, and the scheduler 142 receives the work blocks from another type of processor other than a CPU.

In some implementations, the scheduler 142 assigns work blocks to the partitions 120A and 120B in a round-robin manner. Work blocks assigned to the compute circuits 124A-124B of the die 122A are received by the scheduler 125. Work blocks assigned to the compute circuits 124C-124D of the die 122C are received by the scheduler 127. The following discussion describes further scheduling steps such as assigning work blocks to the dies 122A-122B and 122C-122D. Although the following discussion describes these further scheduling steps being performed by the scheduler 142, in other implementations, the upcoming further scheduling steps are performed by the schedulers 125 and 127. In such implementations, the scheduler 125 performs further scheduling steps for assigning work blocks to the dies 122A-122B of the partition 120A. Similarly, in such implementations, the scheduler 127 performs further scheduling steps for assigning work blocks to the dies 122C-122D of the partition 120B.

In some implementations, the circuitry of the scheduler 142 assigns, for execution, work blocks received to the dies 122A-122B of the partition 120A when the scheduler 125 is not included. As shown, the scheduler 142 (or scheduler 125 when included) sends work blocks as part of the information 126 to the dies 122A-122B. Similarly, the circuitry of the scheduler 142 assigns work blocks for execution to the dies 122C-122D of the partition 120B when the scheduler 127 is not included. As shown, the scheduler 142 (or scheduler 127 when included) sends work blocks as part of the information 128 to the dies 122C-122D. In various implementations, the scheduler 142 assigns work blocks to the dies 122A-122B and the dies 122C-122D in a manner to manage performance among the replicated dies 122A-122B and the dies 122C-122D despite different circuit behavior amongst the dies 122A-122B and the dies 122C-122D due to manufacturing variations.

During the semiconductor manufacturing process steps for the dies 122A-122B and 122C-122D, and prior to packaging these dies in the MCM or other semiconductor package, it is possible that one or more of the compute circuits 124A-124B and 124C-124D and other processors have different circuit behavior than other iterations of these components in another semiconductor package. These differences in behavior result from manufacturing variations across semiconductor dies that inadvertently cause different widths of metal gates and metal traces, different doping levels of source and drain regions, different thicknesses of insulating oxide layers, different thicknesses of metal layers, and so on. These manufacturing variations also affect the threshold voltages of transistors. The semiconductor dies with different circuit behavior are still used, but these semiconductor dies are placed in different performance categories or bins. When the semiconductor package utilizes multiple copies (dies 122B and 122C-122D) of a same semiconductor die (122A) and even when the multiple copies receive a same workload, the behavior of the resulting semiconductor chip can vary depending on which bins the semiconductor dies were selected to be placed in the semiconductor chip.

As described earlier, the die 122A includes the table 126A. In various implementations, the table 126A is implemented with a fuse array, or a fuse read-only memory (ROM). The fuse ROM utilizes electronic fuses (Efuses) that can be programmed during die characterization in a testing environment, but a continued ability to program is not available in the field. Typically, a fuse is blown at manufacturing time, and its state generally can't be changed once blown. Fuses can be used to encode a variety of types of information such as the information stored in table 126A, manufacturing information, such as a chip serial number, and other information. Besides Efuses, it is possible and contemplated that the fuse ROM uses other fuse technologies such as laser and soft fuses. Table 126C and other similar tables within the dies 122B and 122D also use a fuse ROM.

As shown, the memory 160 stores the work block characterization table 164. The memory 160 is representative of any of a variety of types of memory such as static random-access memory (SRAM) used to implement one of an associated local memory or a cache of a particular level of a multi-level cache memory subsystem, one of a variety of types of dynamic RAM (DRAM) used to implement system memory, and a hard disk or flash memory used to implement main memory. In other implementations, the work block characterization table 164 is another type of data structure used for data storage implemented by one of flip-flop circuits, a content addressable memory (CAM), or other.

In various implementations, the table 126A includes information that specifies a performance category or bin for the die 122A. Although the following discussion is directed to the table 126A of die 122A, the description is also applicable to the types of information stored in table 122C of die 122C and other tables in dies 122B and 122D. In an implementation, the table 126A includes information that specifies a maximum operating clock frequency of die 122A. In such an implementation, a higher operating clock frequency specified in the table 126A is used to indicate that the corresponding die 122A provides higher performance with higher performance operating parameters. For example, the corresponding die 122A is from a bin of dies that are capable of operating at a higher operational clock frequency than dies of another lower performance bin.

A lower operating clock frequency specified in the table 126A is used to indicate that the corresponding die 122A does not provide higher performance with higher performance operating parameters. For example, this die 122A is from a lower performance bin of dies that are incapable of operating at a higher operational clock frequency than dies of another higher performance bin. In an implementation, the die 122A is from a high-performance bin, and the table 126A specifies a maximum operating clock frequency of 2.2 gigahertz (GHz) for a unique identifier (ID) that identifies the die 122A. In contrast, the die 122B is from a lower performance bin, and the table 122B specifies a maximum operating clock frequency of 2.0 gigahertz (GHz) for a unique ID that identifies the die 122B.

In various implementations, the work block characterization table 164 (or table 164) includes information that specifies a type of workload for particular work blocks. Similar to software applications, each work block has an associated unique identifier (ID). Some work blocks are associated with a computation intensive workload. These workloads are executed with a smaller latency when higher performance operating parameters are used by corresponding circuitry. Therefore, to reduce execution latency, after accessing one or more of the tables 126A and 126C, and similar tables for dies 122B and 122D, and the table 164, the scheduler 142 assigns work blocks associated with a computation intensive workload to particular dies. In an implementation, these particular dies include one or more of the dies 122A-122B and 122C-122D identified as being from high-performance bins. In an implementation, the scheduler 142 accesses the tables 126A and 126C, and similar tables for dies 122B and 122D during initialization of the apparatus 100, and the scheduler 142 stores a local copy of the information included in these tables. Other workloads are associated with a memory access intensive workload. The latency of these workloads does not reduce when higher performance operating parameters are used by corresponding circuitry. Therefore, after accessing one or more of the tables 126A and 126C, and similar tables for dies 122B and 122D, and the table 164, the scheduler 142 assigns work blocks associated with a memory access intensive workload to particular dies. In an implementation, these particular dies include one or more of the dies 122A-122B and 122C-122D identified as being from lower performance bins.

In some implementations, the dies 122A-122B and 122C-122D are chiplets. As described earlier, a “chiplet” is also referred to as a “functional block,” or an “intellectual property block” (or IP block). However, a “chiplet” is a semiconductor die (or die), such as the dies 122A-122B and 122C-122D, fabricated separately from other dies, and then interconnected with these other dies in a single integrated circuit in the MCM. A chiplet is a type of functional block. However, a functional block is a term that also describes blocks fabricated with other functional blocks on a larger semiconductor die such as the SoC. Therefore, a chiplet is a subset of “functional blocks” in a semiconductor chip. The dies 122A-122B and 122C-122D can also be referred to as functional blocks 122A-122B and 122C-122D. As described earlier, upon accessing the tables 162 and 164, the scheduler 142 (or the schedulers 125 and 127) assigns work blocks to the chiplets 122A-122B and 122C-122D based on whether a chiplet is from a high-performance bin and whether a workload of a work block is a computation intensive workload.

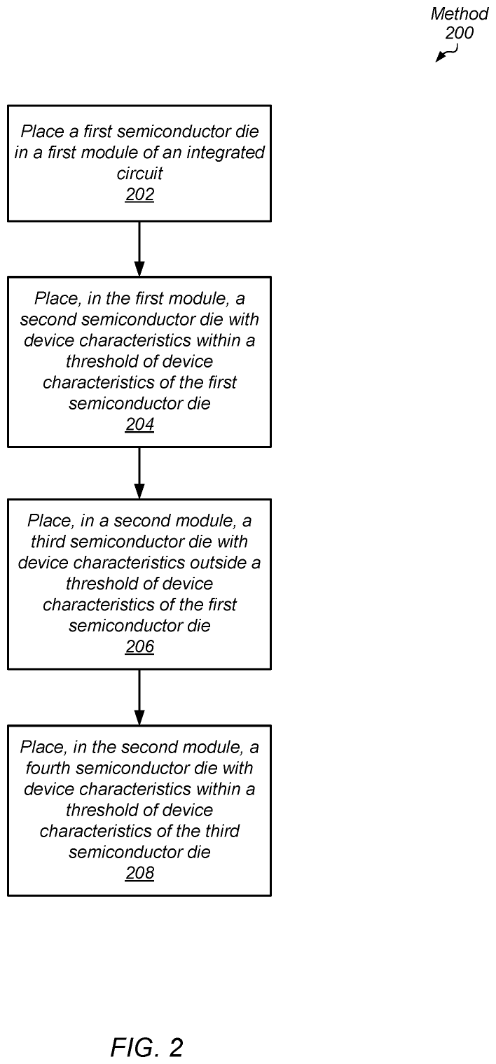

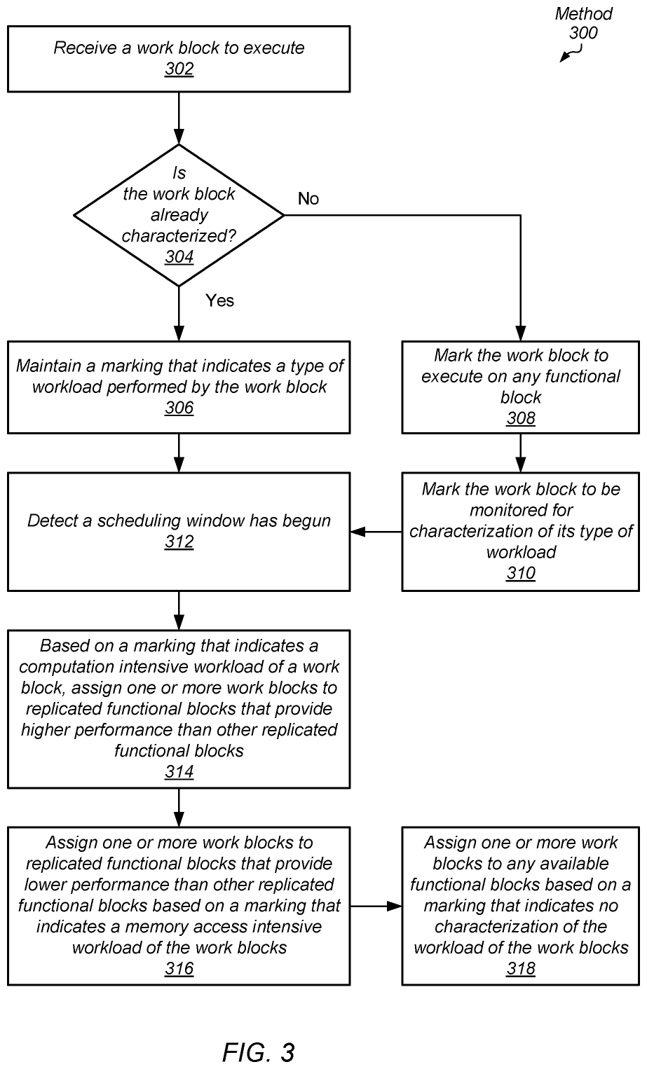

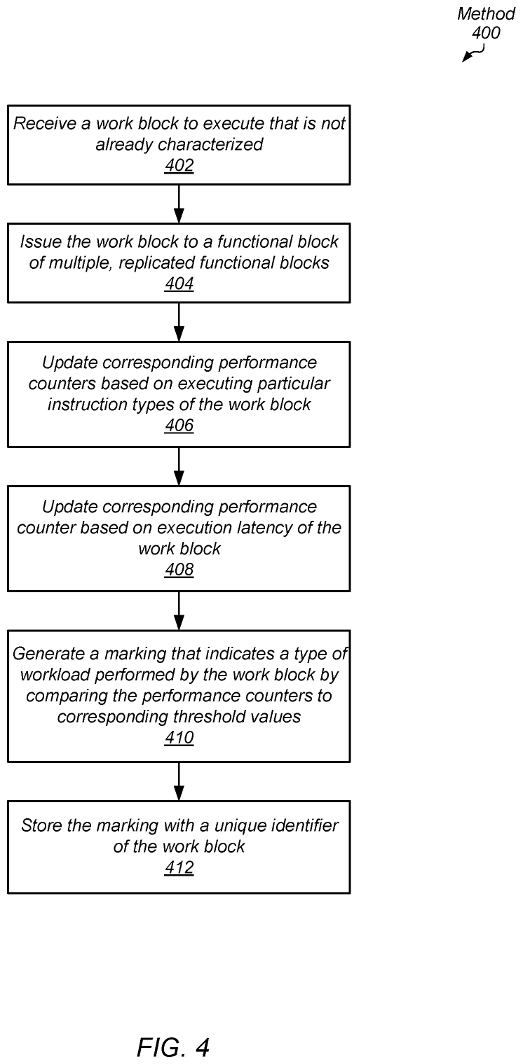

Referring to FIG. 2, a generalized block diagram is shown of a method 200 for efficiently managing performance among replicated modules of an integrated circuit despite different circuit behavior of semiconductor dies due to manufacturing variations. For purposes of discussion, the steps in this implementation (as well as in FIGS. 3-4) are shown in sequential order. However, in other implementations some steps occur in a different order than shown, some steps are performed concurrently, some steps are combined with other steps, and some steps are absent.

An integrated circuit being fabricated includes at least two modules. A first module includes multiple dies in a same first partition where these dies are operable to use a same power domain. Therefore, the multiple dies share at least a same first power rail. Similarly, the second module includes multiple dies in a same second partition operable to use a same power domain. The multiple dies of the second module share at least a same second power rail. In some implementations, the first power rail and the second power rail are a same power rail. In other implementations, the second power rail is different from the first power rail. A first semiconductor die is placed in the first module of an integrated circuit (block 202).

A second semiconductor die with device characteristics within a threshold of device characteristics of the first semiconductor die is placed in the first module (block 204). Examples of the device (transistor) characteristics are widths of metal gated and metal traces, doping levels of source and drain regions, thicknesses of insulating oxide layers, thicknesses of metal layers, values of a minimum power supply voltage, values of threshold voltages of n-type transistors and p-type transistors, and so on. A third semiconductor die with device characteristics outside a threshold of device characteristics of the first semiconductor die is placed in the second module (block 206). A fourth semiconductor die with device characteristics within a threshold of device characteristics of the third semiconductor die is placed in the second module (block 208). Therefore, each of the modules includes dies with similar device characteristics, and these dies are highly likely from a same bin. Across modules, though, the dies are from different bins.

Referring now to FIG. 3, a generalized block diagram is shown of a method 300 for efficiently managing performance among replicated modules of an integrated circuit despite different circuit behavior of semiconductor dies due to manufacturing variations. A scheduler receives a work block to execute (block 302). Examples of work blocks were previously provided. The scheduler accesses one or more tables or other data structures to identify a characterization of the work block such as identifying a type of workload associated with the work block.

If the work block is not already characterized (“no” branch of the conditional block 304), then the scheduler marks the work block to execute on any functional block (block 308). In an implementation, the scheduler stores received work blocks in a queue, and a corresponding queue entry stores program state of the work block. The program state has a field that identifies a functional block or a group of functional blocks of a particular type to use for assignment. The scheduler inserts a particular mark or indication, such as one or more bits that provide a particular value, in this field. In an implementation, the stored program state also includes a program counter and a pointer to work items. If instructions and data of work items are not yet available in the instruction cache and data cache of the assigned functional block, the compute circuit uses the stored program state to fetch instructions and data of work items of the assigned work block.

Additionally, the scheduler also marks the work block to be monitored for characterization of its type of workload (block 310). When marking the work block for monitoring, the scheduler inserts another indication, such as one or more bits that provide a particular value, in another field of the queue entry. This indication specifies to circuitry of a corresponding functional block that tracked values of one or more performance counters should be saved and sent to the scheduler for characterizing the work block based on its execution. The performance counters track, during execution of the work block, a number of times a particular instruction or operation has been executed, such as instruction types regarding branch prediction techniques, cache memory subsystem modeling, memory access patterns, loop iterations, inter-procedural paths, and so forth. Afterward, control flow of method 300 moves to block 312 where the scheduler detects a scheduling window has begun.

If the scheduler determines that the work block is already characterized (“yes” branch of the conditional block 304), then the scheduler maintains a marking that indicates a type of workload performed by the work block (block 306). This marking is part of the program state of the work block stored in the queue. The scheduler detects a scheduling window has begun (block 312). Based on a marking that indicates a computation intensive workload of a work block, the scheduler assigns one or more work blocks to replicated functional blocks that provide higher performance than other replicated functional blocks (block 314).

During the scheduling window, the scheduler assigns one or more work blocks to replicated functional blocks that provide lower performance than other replicated functional blocks based on a marking that indicates a memory access intensive workload of the work blocks (block 316). The scheduler assigns one or more work blocks to any available functional blocks based on a marking that indicates no characterization of the workload of the work blocks (block 318).

Turning now to FIG. 4, a generalized block diagram is shown of a method 400 for efficiently managing performance among replicated functional blocks of an integrated circuit despite different circuit behavior of semiconductor dies due to manufacturing variations. A scheduler receives a work block to execute that is not already characterized (block 402). The scheduler accesses one or more tables or other data structures to identify a characterization of the work block such as identifying a type of workload associated with the work block. However, since the work block has not already been characterized, or its characterization has been rewritten or otherwise invalidated, the scheduler is unable to identify a type of workload associated with the work block. The scheduler issues the work block to a functional block of multiple, replicated functional blocks (block 404). For example, the scheduler assigns the work block to any available functional block based on no characterization of the workload of the work block.

The assigned functional block updates corresponding performance counters based on executing particular instruction types of the work block (block 406). The assigned functional block updates one or more corresponding performance counters based on execution latency of the work block (block 408). One or more of the functional blocks, the scheduler, or another component of the integrated circuit generates a marking that indicates a type of workload performed by the work block by comparing the performance counters to corresponding threshold values (block 410). In an implementation, the marking is a field of one or more bits that indicate a particular value. This value of the marking identifies a type of workload associated with the work block. For example, the marking indicates a computation intensive workload, a memory access intensive workload, or other. One or more of the functional blocks, the scheduler, or another component of the integrated circuit stores the marking with a unique identifier of the work block (block 412). For example, the corresponding component stores the marking among bits of the program state of the work block.

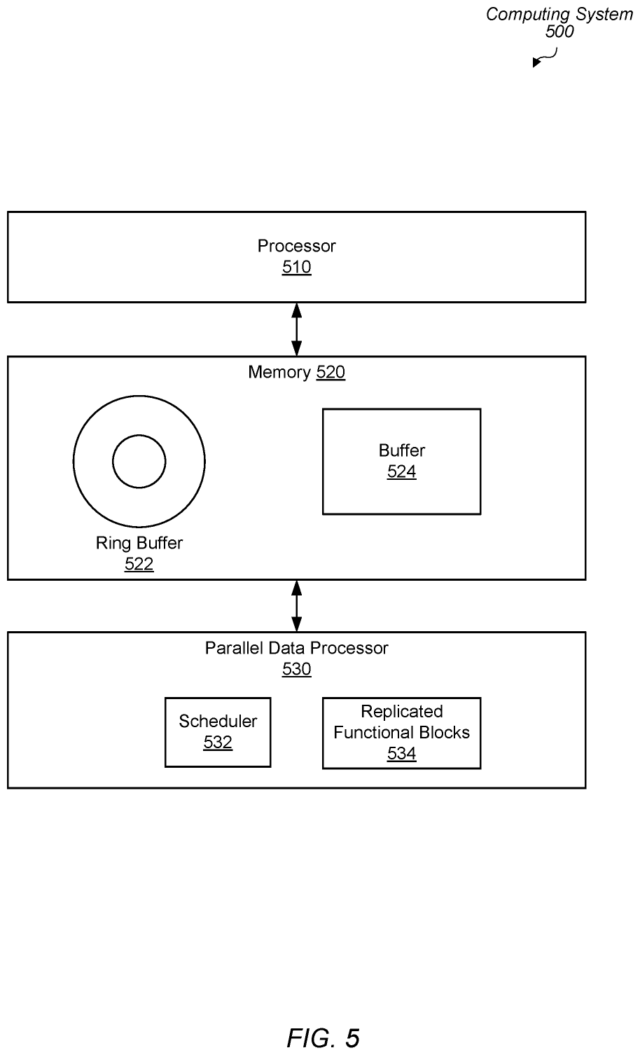

Turning now to FIG. 5, a generalized block diagram is shown of a computing system 500 that efficiently manages performance among replicated functional blocks of an integrated circuit despite different circuit behavior of semiconductor dies due to manufacturing variations. As shown, the computing system 500 includes a processor 510, a memory 520 and a parallel data processor 530. In some implementations, the functionality of the computing system 500 is included as components on a single die, such as a single integrated circuit. In other implementations, the functionality of the computing system 500 is included as multiple dies on a system-on-a-chip (SOC). In other implementations, the functionality of the computing system 500 is implemented by multiple, separate dies that have been fabricated on separate silicon wafers and placed in system packaging known as multi-chip modules (MCMs). In various implementations, the computing system 500 is used in a desktop, a portable computer, a mobile device, a server, a peripheral device, or other.

The circuitry of the processor 510 processes instructions of a predetermined algorithm. The processing includes fetching instructions and data, decoding instructions, executing instructions, and storing results. In one implementation, the processor 510 uses one or more processor cores with circuitry for executing instructions according to a predefined general-purpose instruction set architecture (ISA). In various implementations, the processor 510 is a general-purpose central processor (CPU). The parallel data processor 530 uses one or more processor cores with a relatively wide single instruction multiple data (SIMD) micro-architecture to achieve high throughput in highly data parallel applications. In an implementation, the parallel data processor 530 is a graphics processor (GPU). In other implementations, the parallel data processor 530 is another type of processor. In an implementation, the parallel data processor 530 stores results data in the buffer 524 of the memory 520.

In various implementations, the functional blocks 534 are semiconductor dies that include one or more SIMD circuits with the circuitry of multiple lanes of execution. The scheduler 532 schedules work blocks to the functional block 534 in a manner to manage performance among the replicated functional blocks 534 despite different circuit behavior of the functional blocks 534 due to manufacturing variations. In various implementations, the scheduler 532 includes the functionality of the scheduler 142 (or scheduler 125 or scheduler 127) (of FIG. 1). The work blocks, here, are wave fronts (or waves) of multiple work items. The parallel data processor 530 is efficient for data parallel computing found within loops of applications, such as in applications for manipulating, rendering, and displaying computer graphics. In such cases, each of the data items of a wave front is a pixel of an image. The applications can also include molecular dynamics simulations, finance computations, neural network training, and so forth. The highly parallel structure of the parallel data processor 530 makes it more effective than the general-purpose structure of the processor 510.

In various implementations, threads are scheduled on one of the processor 510 and the parallel data processor 530 in a manner that each thread has the highest instruction throughput based at least in part on the runtime hardware resources of the processor 510 and the parallel data processor 530. In some implementations, some threads are associated with general-purpose algorithms, which are scheduled on the processor 510, while other threads are associated with parallel data computationally intensive algorithms such as video graphics rendering algorithms, which are scheduled on the parallel data processor 530. The functional block 534 can be used for real-time data processing such as rendering multiple pixels, image blending, pixel shading, vertex shading, and geometry shading. Some threads, which are not video graphics rendering algorithms, still exhibit parallel data and intensive throughput. These threads have instructions which are capable of operating simultaneously with a relatively high number of different data elements (or data items). Examples of these threads are threads for scientific, medical, finance and encryption/decryption computations.

To change the scheduling of the above computations from the processor 510 to the parallel data processor 530, software development kits (SDKs) and application programming interfaces (APIs) were developed for use with widely available high-level languages to provide supported function calls. The function calls provide an abstraction layer of the parallel implementation details of the parallel data processor 530. The details are hardware specific to the parallel data processor 530 but hidden to the developer to allow for more flexible writing of software applications. The function calls in high level languages, such as C, C++, FORTRAN, and Java and so on, are translated to commands which are later processed by the hardware in the parallel data processor 530. Although a network interface is not shown, in some implementations, the parallel data processor 530 is used by remote programmers in a cloud computing environment.

A software application begins execution on the processor 510. Function calls within the application are translated to commands by a given API. The processor 510 sends the translated commands to the memory 520 for storage in the ring buffer 522. The commands are placed in groups referred to as command groups. In some implementations, the processors 510 and 530 use a producer-consumer relationship, which is also be referred to as a client-server relationship. The processor 510 writes commands into the ring buffer 522. Circuitry of a controller (not shown) of the parallel data processor 530 reads the commands from the ring buffer 522. In some implementations, the controller is a command processor of a GPU.

The controller sends work blocks to the scheduler 532, which assigns work blocks to one of the functional blocks 534 based on a type of workload associated with the work block. The type of workload can be a computation intensive workload, a memory access intensive workload, or other. For a work block associated with a computation intensive workload, the scheduler 532 assigns the work block to one of the functional blocks 534 from a high-performance bin. For a work block associated with a memory access intensive workload, the scheduler 532 assigns the work block to one of the functional blocks 534 from a lower performance bin. The functional blocks 534 process the commands (instructions) of the assigned work blocks, and writes result data to the ring buffer 522.

In some implementations, one or more of a corresponding one of the functional blocks 534, the scheduler, or another component of the data processor 530 identifies a type of workload performed by the work block when the work block is not already characterized by comparing values of performance counters to corresponding threshold values. The processor 510 is configured to update a write pointer for the ring buffer 522 and provide a size for each command group. The parallel data processor 530 updates a read pointer for the ring buffer 522 and indicates the entry in the ring buffer 522 at which the next read operation will use.

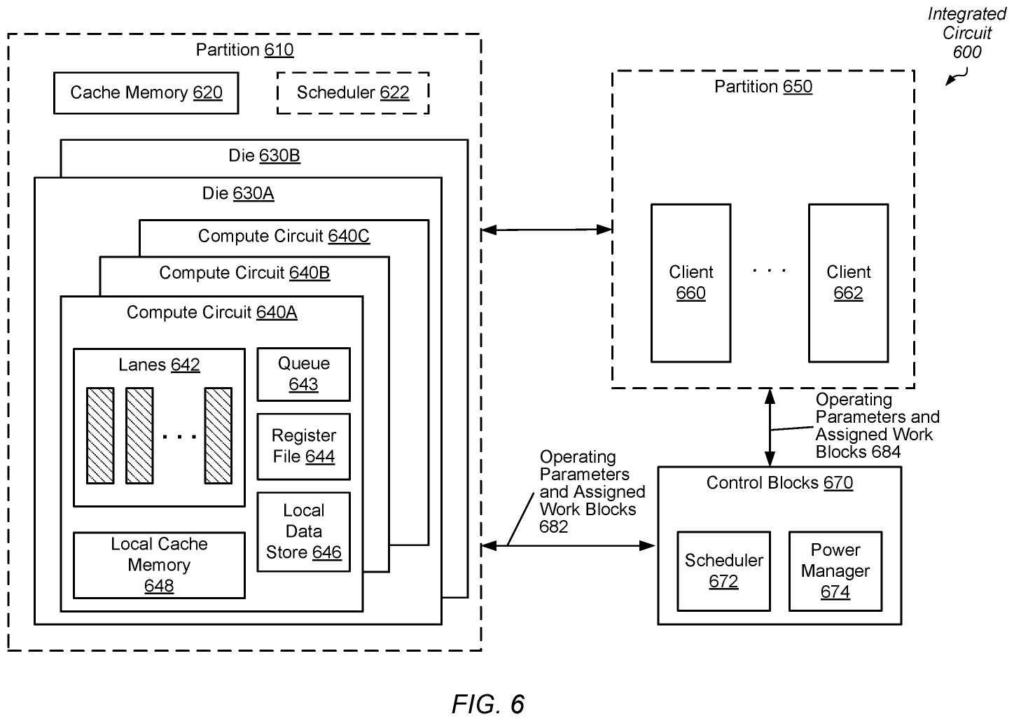

Referring to FIG. 6, a generalized block diagram is shown of an integrated circuit 600 that efficiently manages performance among replicated semiconductor dies of an integrated circuit despite different circuit behavior of semiconductor dies due to manufacturing variations. In the illustrated implementation, the integrated circuit 600 includes two partitions such as partition 610 and partition 650. Each of the partitions 610 and 650 includes components for processing work blocks. Partition 610 includes the cache memory 620 shared by the dies 630A and 630B. The die 630A includes the compute circuits 640A, 640B and 640C. Partition 650 includes the clients 660-662. The control blocks 670 includes the scheduler 672 and the power manager 674. In an implementation, the power manager 674 has the functionality of the power manager 144 (of FIG. 1). In some implementations, the scheduler 672 of the control blocks 670 schedules work blocks on the compute circuits 640A-640C of the partition 610. In other implementations, the scheduler 622 of the partition 610 schedules work blocks on the compute circuits 640A-640C. In various implementations, the scheduler 672 (or the scheduler 622) includes the functionality of the scheduler 142 (or scheduler 125 or scheduler 127 of FIG. 1), or the scheduler 532 (of FIG. 5). Such functionality manages performance among replicated dies 630A-630B of partition 610 despite different circuit behavior of the replicated dies 630A-630B due to manufacturing variations.

A communication fabric, a memory controller, interrupt controllers, and phased locked loops (PLLs) or other clock generating circuitry are not shown for ease of illustration. In some implementations, the functionality of the integrated circuit 600 is included as components on a single die such as a single integrated circuit. In an implementation, the functionality of the integrated circuit 600 is included as one die of multiple dies on a system-on-a-chip (SOC). In other implementations, the functionality of the integrated circuit 600 is implemented by multiple, separate dies that have been fabricated on separate silicon wafers and placed in system packaging known as multi-chip modules (MCMs). In various implementations, the integrated circuit 600 is used in a desktop, a portable computer, a mobile device, a server, a peripheral device, or other.

In some implementations, each of the partitions 610 and 650 is assigned to a respective power domain. In other implementations, each of the partitions 610 and 650 is assigned to a same power domain. A power domain includes at least operating parameters such as at least an operating power supply voltage and an operating clock frequency. A power domain also includes control signals for enabling and disabling connections to clock generating circuitry and one or more power supply references. In the information 682, the partition 610 receives operating parameters of a first power domain from power controller 670. In the information 684, the partition 650 receives operating parameters of a second power domain from the power controller 670.

The clients 660-662 include a variety of types of circuits such as a central processor (CPU), a digital signal processor (DSP), an application specific integrated circuit (ASIC), a field programmable gate array (FPGA), multimedia circuitry, and so forth. Each of the clients 660-662 is capable of processing work blocks of a variety of workloads. In some implementations, work blocks scheduled on the partition 610 include wave fronts and work blocks scheduled on the partition 650 include instructions operating on a single data item not grouped into wave fronts. Additionally, each of the clients 660-662 is capable of generating and servicing one or more of a variety of requests such as memory access read and write requests and cache snoop requests.

In one implementation, the integrated circuit 600 is a graphics processor (GPU). The circuitry of the dies 630A and 630B of partition 610 process highly data parallel applications. The die 630A includes the multiple compute circuits 640A-640C, each with multiple lanes 642. In various implementations, the die 630B includes similar components as the die 630A. In some implementations, the lanes 642 operate in lockstep. In various implementations, the data flow within each of the lanes 642 is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration. Each of the computation circuits within a given row across the lanes 642 is the same computation circuit. Each of these computation circuits operates on a same instruction, but different data associated with a different thread. As described earlier, a number of work items are grouped into a wave front for simultaneous execution by multiple SIMD execution lanes such as the lanes 642 of the compute circuits 640A-640C. Each data item is processed independently of other data items, but the same sequence of operations of the subroutine is used.

As shown, each of the compute circuits 640A-640C also includes a respective queue 643 for storing assigned work blocks, register file 644, a local data store 646, and a local cache memory 648. In some implementations, the local data store 646 is shared among the lanes 642 within each of the compute circuits 640A-640C. In other implementations, a local data store is shared among the compute circuits 640A-640C. Therefore, it is possible for one or more of lanes 642 within the compute circuit 640A to share result data with one or more lanes 642 within the compute circuit 640A based on an operating mode.

In an implementation, the queue 643 is implemented as first-in, first-out (FIFO) buffer. Each queue entry of the queue 643 is capable of storing an assigned work block received from the scheduler 622 (or the scheduler 672). Each queue entry can also be referred to as a “slot.” A slot stores program state of the assigned work block. In various implementations, the compute circuits 640A-640C maintain a count of available slots, or queue entries, in the queues that store assigned work blocks. The compute circuits 640A-640C send this count as information to the scheduler 622 (or the scheduler 672). Although an example of a single instruction multiple data (SIMD) micro-architecture is shown for the compute resources 630, other types of highly parallel data micro-architectures are possible and contemplated. The high parallelism offered by the hardware of the dies 630A-630B is used for simultaneously rendering multiple pixels, but it is also capable of simultaneously processing the multiple data elements of the scientific, medical, finance, encryption/decryption, and other computations.

The clients 660-662 can also include one or more of an analog-to-digital converter (ADC), a scan converter, a video decoder, a display controller, and other compute circuits. In some implementations, the partition 660 is used for real-time data processing, whereas the partition 650 is used for non-real-time data processing. Examples of the real-time data processing are rendering multiple pixels, image blending, pixel shading, vertex shading, and geometry shading. Examples of the non-real-time data processing are multimedia playback, such as a video decoding for encoded audio/video streams, image scaling, image rotating, color space conversion, power up initialization, background processes such as garbage collection, and so forth. Circuitry of a controller (not shown) receives tasks. In some implementations, the controller is a command processor of a GPU, and the task is a sequence of commands (instructions) of a function call of an application. The controller assigns a task to one of the two partitions 610 and 650 based on a task type of the received task. One of the schedulers 672 and 622 receives these tasks from the controller, organizes the tasks as work blocks, if not already done so, and schedules the work blocks on the compute circuits 640A-640C.

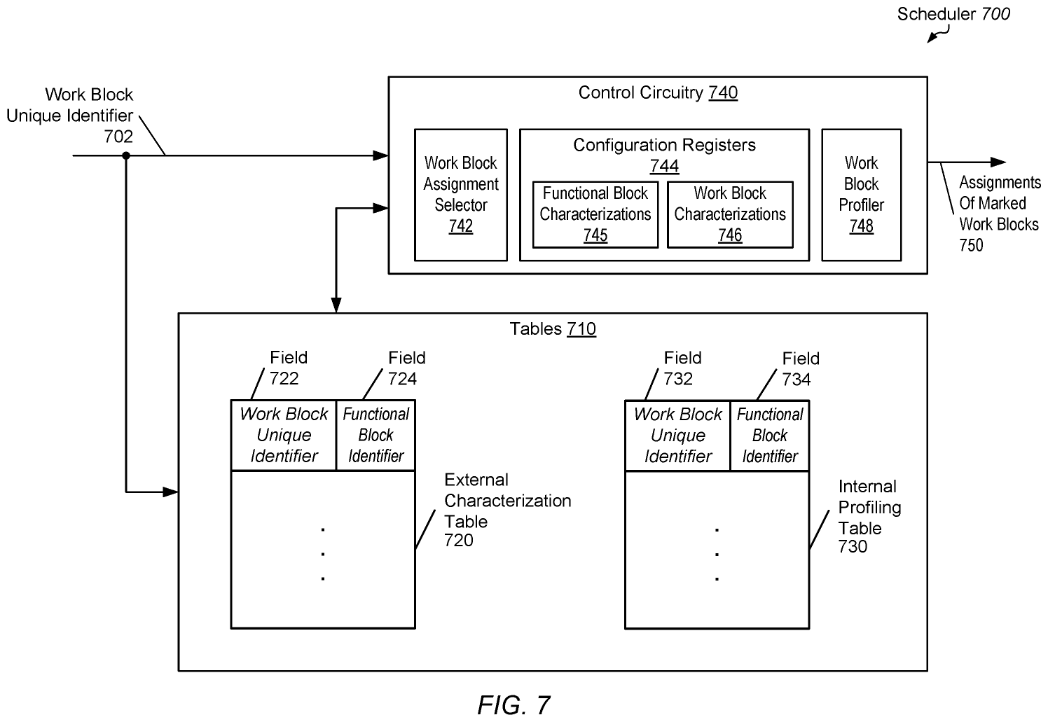

Turning now to FIG. 7, a generalized block diagram is shown of a scheduler 700 that efficiently manages performance among replicated functional blocks, such as semiconductor dies, of an integrated circuit despite different circuit behavior of the functional blocks due to manufacturing variations. As shown, the scheduler 700 includes the tables 710 and the control circuitry 740. The control circuitry 740 receives the work block unique identifier (ID) 702 and information from the tables 710, and generates the work block assignments 750 for multiple, replicated functional blocks of the integrated circuit.

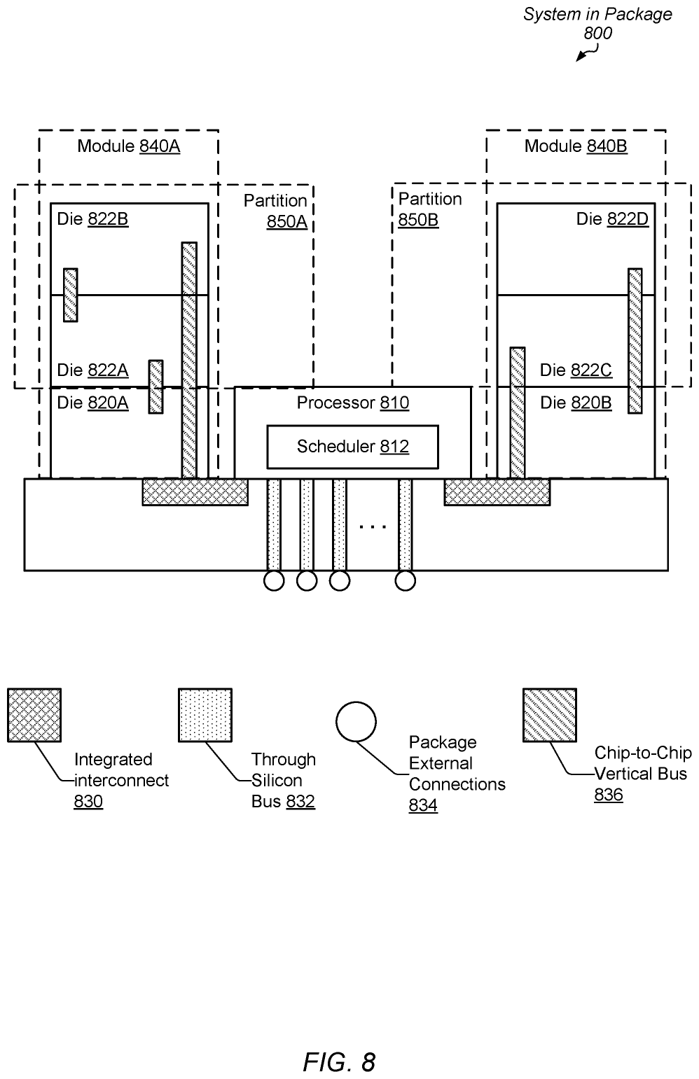

The control circuitry 740 includes the components 742-748 that are used to assign work blocks to multiple, replicated functional blocks. In some implementations, a functional block is a semiconductor die with one or more compute circuits, each being a single instruction multiple data (SIMD) circuit that includes multiple lanes of execution. In an implementation, a functional block is a chiplet. A work block is a wave front that includes multiple work items to be executed by the multiple lanes of execution of a SIMD circuit. In some implementations, one or more of the components of scheduler 700 and corresponding functionality is provided in another external circuit, rather than provided here in scheduler 700. In various implementations, the functionality provided by the scheduler 700 is also provided in the scheduler 125 (or scheduler 127 or scheduler 142) (of FIG. 1), the scheduler 532 (of FIG. 5), the scheduler 672 (or scheduler 622) (of FIG. 6), and the scheduler 812 (of FIG. 8).

The tables 710 are implemented with one of flip-flop circuits, one of a variety of types of a random-access memory (RAM), a content addressable memory (CAM), or other. Although particular information is shown as being stored in the fields 722, 724, 732, and 734, and in a particular contiguous order, in other implementations, a different order is used and a different number and type of information is stored. The external characterization table 720 (or table 720) includes information that characterizes the workload of work blocks based on testing and characterization of the work blocks executed on a particular integrated circuit in a testing environment. The values stored in the table 720 can be set at the time of manufacture of the integrated circuit using the scheduler 700. In some implementations, these values are stored in one of a variety of types of a read only memory (ROM) such as an erasable and programmable ROM (EPROM).

The filed 722 stores a work block unique ID and the field 724 stores a functional block unique ID. Therefore, a mapping exists between work block and functional block for one or more work blocks. The work block assignment selector 742 (or selector 742) can simply use this mapping for assigning the corresponding work block. In other implementations, the field 724 stores an indication specifying a type of workload of the work block. The selector 742 can use this identified type of workload to assign the corresponding work block. As described earlier, the selector 742 can assign work blocks having a computation intensive workload to functional blocks that provide higher performance with higher performance operating parameters. The selector 742 can also assign work blocks identified as having a memory access intensive workload to functional blocks that do not provide higher performance with higher performance operating parameters.

The internal profiling table 730 (or table 730) includes information that characterizes the workload of work blocks based on profiling of the work blocks during execution on the integrated circuit. As described earlier, performance counters on the integrated circuit can track, during execution of the work block, a number of times a particular instruction or operation has been executed, such as instruction types regarding branch prediction techniques, cache memory subsystem modeling, memory access patterns, loop iterations, inter-procedural paths, and so forth. The work block profiler 748 generates a marking that indicates a type of workload performed by a particular work block by comparing the performance counters to corresponding threshold values. This marking is used to update the table 730. The fields 732 and 734 store values similar to the fields 722 and 724.

The values stored in the configuration registers 744 can be read from one of a variety of types of a ROM and stored in one of flip-flop circuits, one of a variety of types of a random-access memory (RAM), a content addressable memory (CAM), or other. The configuration registers 744 include the functional block characterizations 745 that include a mapping between functional block unique identifiers and types of functional blocks. The types of functional blocks can be a field of one or more bits indicating whether a corresponding functional block is from a high-performance bin or a lower performance bin. Other intermediate types of bins are also possible and contemplated. In various implementations, during initialization of a corresponding integrated circuit, the scheduler 700 reads tables implemented as Efuse ROMs that store the mapping information. These Efuse ROMs store data in a manner similar to the tables 122A, 122C, and similar tables of dies 122B and 122D (of FIG. 1). The scheduler 700 stores these mappings accessed during initialization in the configuration registers 744 as the functional block characterizations 745.

In an implementation, the functional block characterizations 745 specify maximum operating clock frequencies of functional blocks, which are used to characterize the functional blocks. For example, an indication of 2.2 gigahertz (GHz) for a functional block can be used to identify the functional block as being from a high-performance bin. In contrast, an indication of 2.0 GHz for a functional block can be used to identify the functional block as being from a lower performance bin. The selector 742 can use the information of the functional block characterizations 745 when generating the work block assignments 750. The work block characterizations 746 can store a local copy of a subset of the information of the tables 710.

Turning now to FIG. 8, a generalized block diagram is shown of a system-in-package (SiP) 800 that efficiently manages performance among replicated semiconductor dies of an integrated circuit despite different circuit behavior of the semiconductor dies due to manufacturing variations. In various implementations, three-dimensional (3D) packaging is used within a computing system. This type of packaging is referred to as a System in Package (SiP). A SiP includes one or more three-dimensional integrated circuits (3D ICs). A 3D IC includes two or more layers of active electronic components integrated both vertically and/or horizontally into a single circuit. In one implementation, interposer-based integration is used whereby the 3D IC is placed next to the processor 810. Alternatively, a 3D IC is stacked directly on top of another IC.

Die-stacking technology is a fabrication process that enables the physical stacking of multiple separate pieces of silicon (integrated chips) together in a same package with high-bandwidth and low-latency interconnects. In some implementations, the die is stacked side by side on a silicon interposer, or vertically directly on top of each other. One configuration for the SiP is to stack one or more semiconductor dies (or dies) next to and/or on top of a processor such as processor 810. In an implementation, the SiP 800 includes the processor 810 and the modules 840A-840B. Module 840A includes the semiconductor die 820A and the multiple three-dimensional (3D) semiconductor dies 822A-822B within the partition 850A. Although two dies are shown, any number of dies is used as stacked 3D dies in other implementations.

In a similar manner, the module 840B includes the semiconductor die 820B and the multiple 3D semiconductor dies 822C-822D within the partition 850B. Although not shown, each of the dies 822A-822B and dies 822C-822D include one or more compute circuits. In various implementations, the hardware, such as circuitry, of each of the dies 822B and 822C-822D is an instantiated copy of the circuitry of the die 822A. The scheduler 812 schedules work blocks on the compute circuits within the dies 822A-822B and 822C-822D in a manner to reduce the voltage droop on the compute circuits. In various implementations, the scheduler 812 includes the functionality of the scheduler 142 (or scheduler 125 or scheduler 127) (of FIG. 1), the scheduler 532 (of FIG. 5), the scheduler 672 (or scheduler 622) (of FIG. 6), and the scheduler 700 (of FIG. 7). The scheduler 812 performs the scheduling steps described to manage performance among replicated semiconductor dies, such as the dies 822A-822B and the dies 822C-822D, despite different circuit behavior of the semiconductor dies due to manufacturing variations.

The dies 822A-822B within the partition 850A share at least a same power rail. In some implementations, the dies 822A-822B also share a same clock signal. In other implementations, the dies 822A-822B have clock signals. The operating parameters of the partition 850B is setup in a similar manner as the operating parameters of the partition 850A. In some implementations, another module is placed adjacent to the left of module 840A that includes a die that is an instantiated copy of the die 820A.

Each of the modules 840A-840B communicates with the processor 810 through horizontal low-latency interconnect 830. In various implementations, the processor 810 is a general-purpose central processor; a graphics processor (GPU), an accelerated processor (APU), a field programmable gate array (FPGA), or other data processing device. The in-package horizontal low-latency interconnect 830 provides reduced lengths of interconnect signals versus long off-chip interconnects when a SiP is not used. The in-package horizontal low-latency interconnect 830 uses particular signals and protocols as if the chips, such as the processor 810 and the modules 840A-840B, were mounted in separate packages on a circuit board. In some implementations, the SiP 800 additionally includes backside vias or through-bulk silicon vias 832 that reach to package external connections 834. The package external connections 834 are used for input/output (I/O) signals and power signals.

In various implementations, multiple device layers are stacked on top of one another with direct vertical interconnects 836 tunneling through them. In various implementations, the vertical interconnects 836 are multiple through silicon vias grouped together to form through silicon buses (TSBs). The TSBs are used as a vertical electrical connection traversing through a silicon wafer. The TSBs are an alternative interconnect to wire-bond and flip chips. The size and density of the vertical interconnects 836 that can tunnel between the different device layers varies based on the underlying technology used to fabricate the 3D ICs.

As shown, some of the vertical interconnects 836 do not traverse through each of the modules 840A-840B. Therefore, in some implementations, the processor 810 does not have a direct connection to one or more dies such as die 822D in the illustrated implementation. Therefore, the routing of information relies on the other dies of the SiP 800. In various implementations, the dies 822A-822B and 822C-822D are chiplets. As described earlier, a “chiplet” is also referred to as an “intellectual property block” (or IP block). However, a “chiplet” is a semiconductor die (or die) fabricated separately from other dies, and then interconnected with these other dies in a single integrated circuit in the MCM.

On a single silicon wafer, only multiple chiplets are fabricated as multiple instantiated copies of particular integrated circuitry, rather than fabricated with other compute circuits that do not use an instantiated copy of the particular integrated circuitry. For example, the chiplets are not fabricated on a silicon wafer with various other compute circuits and processors on a larger semiconductor die such as an SoC. A first silicon wafer (or first wafer) is fabricated with multiple instantiated copies of integrated circuitry a first chiplet, and this first wafer is diced using laser cutting techniques to separate the multiple copies of the first chiplet.

A second silicon wafer (or second wafer) is fabricated with multiple instantiated copies of integrated circuitry of a second chiplet, and this second wafer is diced using laser cutting techniques to separate the multiple copies of the second chiplet. The first chiplet provides functionality different from the functionality of the second chiplet. One or more copies of the first chiplet is placed in an integrated circuit, and one or more copies of the second chiplet is placed in the integrated circuit. The first chiplet and the second chiplet are interconnected to one another within a corresponding MCM. Such a process replaces a process that fabricates a third silicon wafer (or third wafer) with multiple copies of a single, monolithic semiconductor die that includes the functionality of the first chiplet and the second chiplet as integrated compute circuits within the single, monolithic semiconductor die

Process yield of single, monolithic dies on a silicon wafer is lower than process yield of smaller chiplets on a separate silicon wafer. In addition, a semiconductor process can be adapted for the particular type of chiplet being fabricated. With single, monolithic dies, each die on the wafer is formed with the same fabrication process. However, it is possible that an interface compute circuit does not require process parameters of a semiconductor manufacturer's expensive process that provides the fastest devices and smallest geometric dimensions that are beneficial for a high throughput processor on the die. With separate chiplets, designers can add or remove chiplets for particular integrated circuits to readily create products for a variety of performance categories. In contrast, an entire new silicon wafer must be fabricated for a different product when single, monolithic dies are used. It is possible and contemplated that the dies 122A-122D (of FIG. 1), the replicated functional blocks 534 (of FIG. 5), and the compute resources 630 or the partition 610 (of FIG. 6) are implemented as chiplets as well.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high level programming language such as C, or a design language (HDL) such as Verilog, VHDL, or database format such as GDS II stream format (GDSII). In some cases the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVER, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An integrated circuit comprising:
a plurality of functional blocks, each representing an instantiated copy of integrated circuitry configured to process one or more work blocks; and
circuitry configured to:
receive a first work block;
assign the first work block to a first functional block of the plurality of functional blocks that provides higher performance than one or more other replicated functional blocks of the plurality of functional blocks, in response to the first work block including a first type of workload; and
execute the first work block on the first functional block.

2. The integrated circuit as recited in claim 1, wherein the circuitry is further configured to assign a second work block different from the first work block to a second functional block of the plurality of functional blocks that provides lower performance than one or more other replicated functional blocks of the plurality of functional blocks, in response to the second work block including a second type of workload different from the first type of workload.

3. The integrated circuit as recited in claim 2, wherein the first type of workload is a computation intensive workload.

4. The integrated circuit as recited in claim 2, wherein the second type of workload is a memory access intensive workload.

5. The integrated circuit as recited in claim 2, wherein the circuitry is further configured to identify a performance level of one or more of the plurality of functional blocks based on identifiers of the plurality of functional blocks.

6. The integrated circuit as recited in claim 2, wherein the circuitry is further configured to identify a performance level of one or more work blocks based on monitored behavior of the one or more work blocks during previous execution of the one or more work blocks using the plurality of functional blocks.

7. The integrated circuit as recited in claim 6, wherein the circuitry is further configured to maintain a plurality of mappings between identifiers of one or more work blocks and identifiers of corresponding functional blocks of the plurality of functional blocks.

8. A method comprising:
sending, by a processor, one or more work blocks to a scheduler;
receiving, by the scheduler, a first work block;
assigning, by the scheduler, the first work block to a first functional block of a plurality of functional blocks that provides higher performance than one or more other functional blocks of the plurality of functional blocks, responsive to the first work block including a first type of workload; and
executing, by the first functional block, the first work block.

9. The method as recited in claim 8, further comprising assigning, by the scheduler, a second work block different from the first work block to a second functional block of the plurality of functional blocks that provides lower performance than one or more other replicated functional blocks of the plurality of functional blocks, responsive to the second work block including a second type of workload different from the first type of workload.

10. The method as recited in claim 9, wherein the first type of workload is a computation intensive workload.

11. The method as recited in claim 9, wherein the second type of workload is a memory access intensive workload.

12. The method as recited in claim 9, further comprising identifying, by the scheduler, a performance level of one or more of the plurality of functional blocks based on identifiers of the plurality of functional blocks.

13. The method as recited in claim 9, further comprising identifying, by the scheduler, a performance level of one or more work blocks based on monitoring behavior of the one or more work blocks during previous execution of the one or more work blocks using the plurality of functional blocks.

14. The method as recited in claim 13, wherein the scheduler is further configured to maintain a plurality of mappings between identifiers of one or more work blocks and identifiers of corresponding functional blocks of the plurality of functional blocks.

15. A computing system comprising:
a scheduler;
a processor comprising circuitry configured to send one or more work blocks to the scheduler; and
a plurality of chiplets, each comprising one or more compute circuits comprising circuitry configured to process a work block; and
wherein the scheduler comprises circuitry configured to:
receive a first work block;
assign the first work block to a first chiplet of the plurality of chiplets that provides higher performance than one or more other chiplets of the plurality of chiplets, in response to the first work block including a first type of workload; and
wherein the first chiplet is configured to execute the first work block.

16. The computing system as recited in claim 15, wherein the scheduler is further configured to assign a second work block different from the first work block to a second chiplet of the plurality of chiplets that provides lower performance than one or more other replicated chiplets of the plurality of chiplets, in response to the second work block including a second type of workload different from the first type of workload.

17. The computing system as recited in claim 16, wherein the first type of workload is a computation intensive workload.

18. The computing system as recited in claim 16, wherein the second type of workload is a memory access intensive workload.

19. The computing system as recited in claim 16, wherein the scheduler is further configured to identify a performance level of one or more work blocks based on monitoring behavior of the one or more work blocks during previous execution of the one or more work blocks using the plurality of chiplets.

20. The computing system as recited in claim 19, wherein the scheduler is further configured to maintain a plurality of mappings between identifiers of one or more work blocks and identifiers of corresponding chiplets of the plurality of chiplets.
